(19) United States
(12) Patent Application Publication
(10) Pub. No.: US 2002/0073336 A1
(43) Pub. Date: Jun. 13, 2002

(54) Method and apparatus for encrypted electronic file access control

(75) Inventors: Edward J. Toy, Pleasanton, CA (US); David E. Richter, Mountain Ranch, CA (US)

Correspondence Address: Michael E. Woods, McCutchen, Doyle, Brown & Enersen LLP, 25th Floor, Three Embarcadero, San Francisco, CA, 94111, US

(73) Assignee: E L & Associates, Inc., Pleasanton, CA

(21) Appl. No.: 09/895,842

(22) Filed: Jun. 29, 2001

Related U.S. Application Data
(60) Provisional application No. 60/215,563, filed on Jun. 30, 2000.

(51) Int. Cl. H04L 9/00

(52) U.S. Cl. 713/201

(57) ABSTRACT

An electronic file is specially encrypted and selectively decrypted into volatile memory to protect the decrypted electronic file from access except through the decrypting process.

### CROSS-REFERENCES TO RELATED APPLICATIONS

This application claims priority of Provisional Application No. 60/215,563, filed Jun. 30, 2000, which is incorporated herein by reference for all purposes.

### BACKGROUND OF THE INVENTION

This invention relates generally to the encryption and decryption of electronic files, and more specifically to controlling access to a plaintext content of a decrypted electronic file.

With the increasing complexity of programs and computer systems, electronic files increasingly embody valuable Intellectual Property (“IP”) of all types: trade secret, know how, show how, copyright and others. This IP is sometimes owned by one company and licensed to other companies, and the electronic file is often provided to these other companies after the license has been negotiated. Enforcing and ensuring protection of the IP in this electronic file is difficult as protection mechanisms are typically limited to non-technical solutions such as, for example, a set of contracts and non-disclosure agreements between the licensor and the licensee. There are several problems with such licensing:

The employees and others who the licensee requires access the electronic file may make copies of it, modify it in unintended ways, or release it to others that have not been licensed, notwithstanding the contracts and agreements that are in place.

The employees and others who the licensee requires access the electronic file may look at and use knowledge of the content of the electronic file to find ways to use the electronic file that are not in the interests of the owner of the IP.

If the licensee uses the electronic file as part of a larger computer system or program that is provided to customers of the licensee, it may be difficult to control access to the IP by customers that are not authorized to access it.

The licensor may have set a licensing fee that is to be collected based on the number of licensee customers that the program is distributed to. Currently the licensor must trust the licensee to provide accurate numbers for the number of customers that the product has been distributed to.

Licensed Intellectual Property in electronic form typically falls into broad groups, including:

1. Program binary code

2. Program source code

3. Input data used in existing programs, including text, audio, video electronic files.

Program binary code is a common existing means of providing electronic files because licensee's programmers cannot easily understand the binary code, giving some measure of protection to the IP. The program binary code is pre-built by the licensor for a common set of computing platforms, consisting of a particular set of hardware and operating system versions.

This limits the usefulness of the electronic file for the following reasons. If the licensee wishes to use the licensed IP on a non-supported platform the licensor will often charge a fee to port the program binary code to the new platform should the licensor even elect to undertake the task. Licensed program binary code is often designed to be linked into a larger program that the licensee is building. If the licensee wishes to use a different source language or different version of the source compiler than the licensor built the program binary code with there may be inter-operability problems that preclude the licensee using development tools that it prefers.

Program source code is human readable instructions that are used as an input to a program translating system to produce other programs. As was discussed above, there are many disadvantages from the licensor's point of view that are attendant to a licensee's direct access of the content of an electronic file. The program source code is usually for a compiled language translator that converts the source code to binary code that is then released to the licensee's customers. This prevents the IP in source form from being widely distributed to licensee's customers. In some cases as also discussed above, a licensee desires to distribute an uncompiled version of the electronic file to its customers.

Input data used in existing programs are embodied in electronic files that may be used as control and configuration data for a generic program. Examples of this include integrated circuit cell library information used in timing and placement programs and interpreted source code used as input to an interpreting program translator. The latter can actually be thought of as program source code that is usually provided to the licensee's customers. It is not commonly done for licensed program source code because of the lack of protection of the source code from the customers of the licensee.

Programming language translators generally come in two varieties: compiled and interpreted. Compiled program translators, called compilers, take a program's source, transform it into binary code and then write the binary code out. The binary code can then be executed without reference to the source code. This provides a number of safeguards for the owner of the source code, insofar as users of the program never see the source code, it cannot be modified and program restrictions (such as licensing) cannot be subverted. Examples of common compiled languages are C, C++, and Pascal.

Interpreted program translators, called interpreters, act by reading the program source code and immediately running the program. The interpreter needs the source code available at all times. Some interpreters are able to transform the source code program into a simple intermediate form that can be run, but it is a fairly simple matter to un-transform the intermediate form into source code that is able to be read by a user of the program. Interpreted programs are often used for smaller tools or for internal use only programs where there is no licensing and having source code available to all users is not a problem. Interpreted programs are generally easier and quicker to develop and change by the programmer. Examples of interpreted languages are Perl, TCL, Java, Basic, and a number of small control languages built into larger tools,

The delineation between interpreted and compiled language translators is a somewhat grey one. Although most translators for C are compilers there do exist interpreters for C. Most Java “compilers” are translators that write out an intermediate form that is then interpreted by a Java runtime package.

It would be advantageous to have the ability to develop programs using interpreted languages, which are easier for the programmer, but still to have strong license controls for these programs when they are distributed to users. The source code of the program must not be available to the users even if they are running an interpreter.

If the program can connect to a licensing mechanism, then the use of the program can be controlled so that only a maximum number of licensed copies can be in use at one time, and some optional features of the program can be enabled or disabled.

It is known to use encryption in association with electronic files to inhibit access by unauthorized users. Unfortunately, once decrypted, the user has direct, unrestricted access to the plaintext content of the electronic file.

### SUMMARY OF THE INVENTION

The present invention provides an efficient solution to distribution of electronic files that permit greater access and use by a user of valuable rights embodied in the content of the electronic file. The preferred embodiment encrypts the electronic file in such a way that the contents of the electronic file are no longer human readable or directly usable by programs, which protects the IP. The program using the electronic file may be either an interpreted program translator or some other data using program. The mechanism to decrypt the data, often a key, is transferred from a licensing source based on whether the particular customer or program is licensed to access the contents at the time of the request. The encrypted electronic file may be either a separate file that is read by the program or be data that is embedded into the program itself. The licensing source may be a separate license server, or also incorporated into the program itself, or provided as part of the electronic file.

In the preferred embodiment, the electronic file is never completely decrypted at one time, but is decrypted in parts in memory. As the electronic file is decrypted, requested plaintext portions are provided to the program flow that requires it in small parts so that anyone accessing a memory image of the plaintext will not be able to see and understand the decrypted IP.

The electronic file may be pre-processed before encryption and post-processed after decryption to transform and tokenize the data in order to minimize size or to make even the decrypted data parts that are in memory more difficult to find. The electronic file may be multiply encrypted, once by the licensor to allow only a particular licensee to access the plaintext content, and then again by the licensee to limit access to particular customers.

It is a preferred embodiment of the present invention to provide a method of accessing an electronic file. The method includes querying a license server associated with an encrypted version of the electronic file in response to a read access request to the electronic file, issuing a token from the license server according to an access policy when access to the electronic file is authorized; and decrypting the encrypted version of the electronic file to a volatile memory using the token to produce the electronic file.

It is another aspect of the preferred embodiment of the present invention to provide a method of producing an electronic file having embedded access control. The method includes encrypting the electronic file with a first key to produce an encrypted electronic file; and associating the encrypted electronic file with an access executable and a license server having an access policy for the electronic file, both operable on a computing system, the license server responsive to an access request from the access executable to issue a first token to the access executable according to the first key and the access policy, and the access executable responsive to the first token to decrypt the encrypted electronic file into a volatile memory protected by the access executable.

It is yet another aspect of the preferred embodiment of the present invention to provide a method of providing access to a process executing on a computing system of an encrypted electronic file containing a plain electronic file. The method includes issuing an access instruction from the process to access the plain electronic file; querying a license server associated with the encrypted electronic file in response to the access instruction; issuing a token from the license server according to an access policy when access to the plain electronic file is authorized, the token containing access authorization instructions; and decrypting so much of the encrypted electronic file to a volatile memory as authorized by said access authorization instructions to write all or a portion of the plain electronic file into the volatile memory; and providing controlled access of the portion of the plain electronic file in the volatile memory to the process while inhibiting all other accesses to the volatile memory by other processes.

Alternate preferred embodiments of the present invention provide for systems and apparatus that prepare and/or use encrypted files according to the preferred embodiments described above. The apparatus includes a general purpose computing system configured with a central processing unit, memory (volatile and non-volative including both removable and non-removable media), I/O and a display coupled to a display memory. Instructions stored in memory configure the computing system to implement parts of the preferred embodiment. General purpose computing systems are well-known and will not be further described herein.

Further understanding of the nature and advantages of the invention may be realized by reference to the remaining portions of the Specification and Drawings. In the drawings, similarly numbered items represent the same or functionally equivalent structures.

### BRIEF DESCRIPTION OF THE DRAWINGS

FIG. 1 is a flowchart illustrating a sequence of steps involved in creating and using encrypted electronic files according to the preferred embodiment;

FIG. 2 is a block diagram representing an Encryption and Licensing Header, listing common fields according to the preferred embodiment;

FIG. 3 is a flowchart illustrating a sequence of steps involved in creating and distributing an Encryption and Licensing Reader to be added onto a software program;

FIG. 4 is a flowchart illustrating a sequence of steps to encrypt and distribute an electronic file according to the preferred embodiment of the present invention; and

FIG. 5 is a flowchart illustrating a sequence of steps the Encryption and Licensing Reader executes to decrypt intellectual property and make it available to the software program.

### DESCRIPTION OF THE SPECIFIC EMBODIMENTS

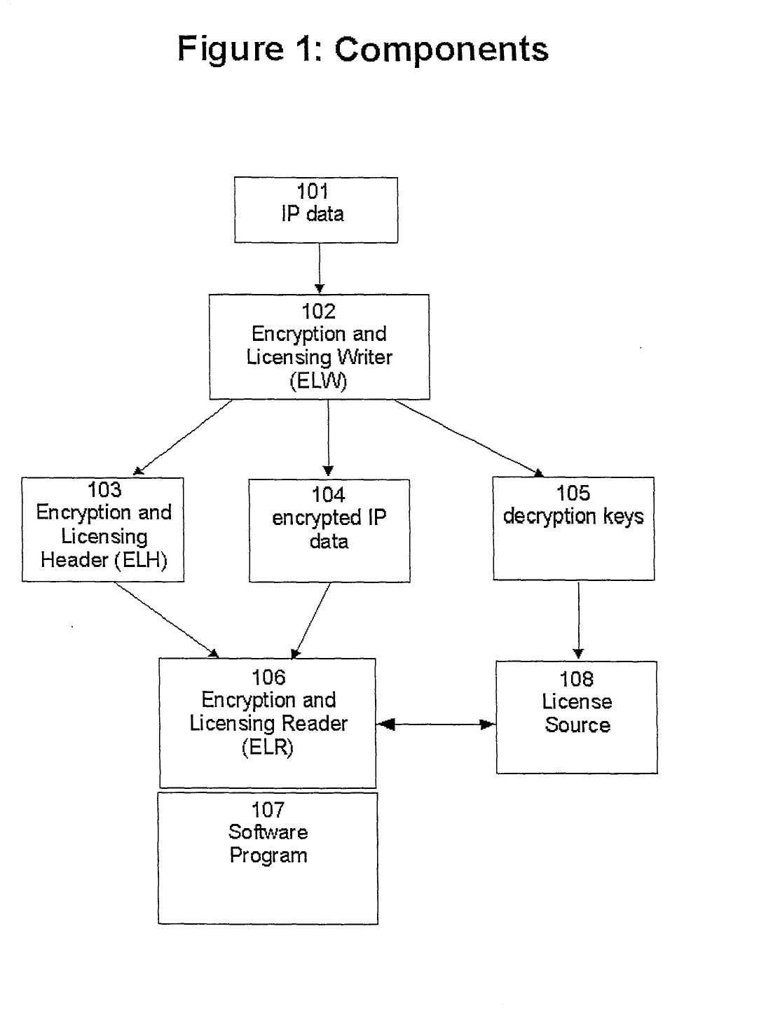

The preferred embodiment of the present invention includes an encryption and licensing process 100 that includes several components as shown in FIG. 1. An electronic file 101 containing intellectual property to be protected is input to a software program, the Encryption and Licensing Writer (ELW) 102. ELW 102 produces three output components: an Encryption and Licensing Header (ELH) 103 containing information on how to obtain licenses and use the applicable decryption methodology (e.g. decryption keys) to decrypt the encrypted electronic file 104; one or more decryption keys 105 (depending upon the application) are transmitted to a license source 108 in a form suitable to be read by the Encryption and Licensing Reader (ELR) 106 which is a binary program component that is attached to the software program 107 that wishes to use electronic file 101. ELR 106 may be dynamically attached to the software program at run-time if the software program supports such connections. Otherwise, ELR 106 is built into the software program. For purposes of simplifying the discussion, the preferred embodiment will be described by use of keys for decryption, though other embodiments may provide for other encryption/decryption methodologies. Further, encryption and decryption algorithms have become well-known, therefore the specifics of the provision and operation of encryption/decryption systems will not be described herein.

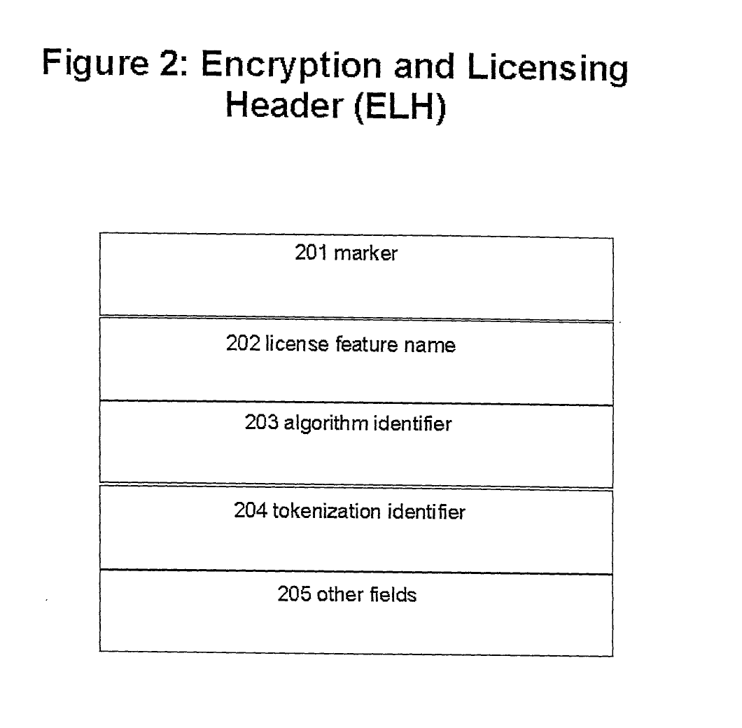

ELH 103 is further described in FIG. 2, where a number of fields are given, including a marker field 201 that allows the ELR 106 to determine whether a decrypted ELH 103 is correct. ELR 106 decrypts ELH 103 and checks that the marker field is an expected value. This might be a constant value of some kind (such as the string “ELH”) or be a value determined by some function of other information available to ELR 106 (such as, for example, the license key used to decrypt ELH 103 and the marker value should combine to make a specific value, such as exclusive-oring to zero).

The license feature name field of ELH 103 is used by ELR 106 to make a request to license source 108 for a decryption key for encrypted electronic file 104. An algorithm identifier field 203 instructs ELR 106 which of possibly several available decryption algorithms should be used to decrypt encrypted electronic file 104. Similarly a tokenization identifier field 204 tells ELR 106 which of possibly several available tokenization and transformation algorithms were performed on electronic file 101 before encryption. Some of these algorithms may need to be reversed before electronic file 101 is usable by the process.

Other embodiments may include other fields 205 in ELH 103 depending upon conventions used between ELW 102 and ELR 106. These fields might convey a checksum of some part of electronic file 101 or encrypted electronic file 104, auditing information, control for other aspects of electronic file 101 such as expiration dates or number of concurrent copies of or accesses to that may be made with respect to electronic copy 101, or any other information that ELW 102 may want to provide to ELR 106.

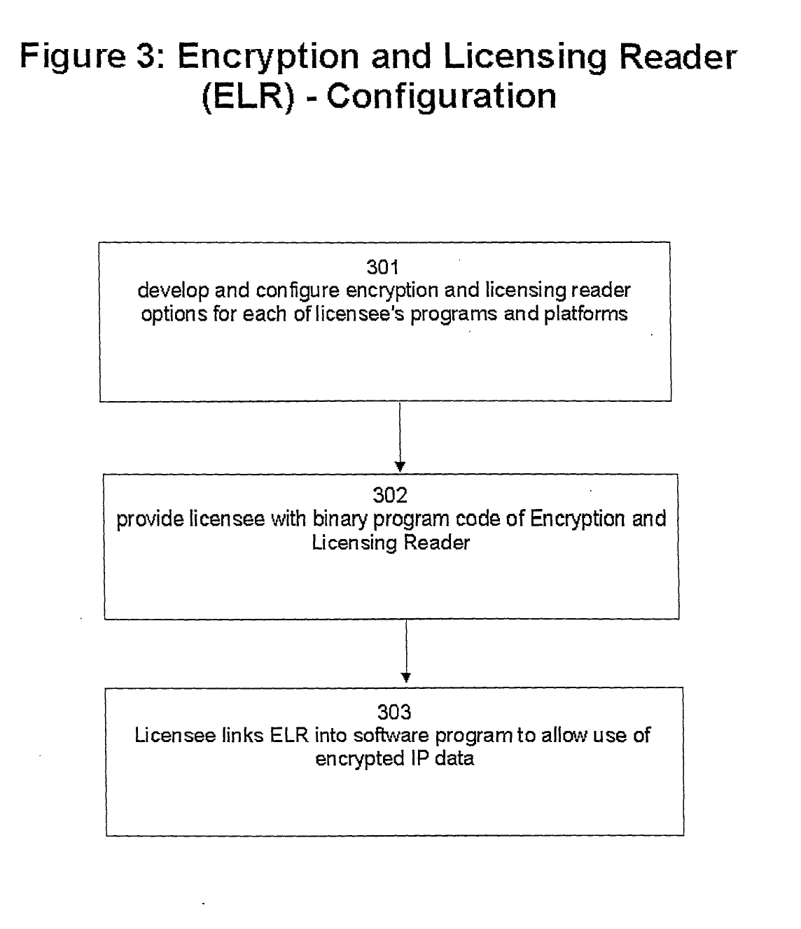

In the preferred embodiment, ELR 106 is created and customized by the licensor as shown in FIG. 3. The licensor develops a software program and customizes and builds it for the particular environment to be used at the customer's site (step 301). That includes considerations of how the licensee's program accesses electronic file 101 and therefore how ELR 106 should provide data into the remaining software program; what type of platform and binary interface that the licensee's program will be running on; whether ELR 106 may be dynamically attached to the software program at run-time or whether ELR 106 should be linked by the licensee into the software program before it is distributed to customers; what decryption algorithms should be made available; what tokenization and transformation algorithms should he made available; what types of license sources will be used; how keys from the license sources and ELH 103 should be combined to decrypt the IP data; what kinds of optional fields in ELH 103 should be available and how they should be used. In the preferred embodiment, all of this customization information is encoded into ELR 106 that decrypts encrypted electronic file 104 and made available as a configuration for ELW 102 that encrypts electronic file 101. In the preferred embodiment, the customized ELR 106′ is distributed to a licensee (step 302) where it may be incorporated into the distribution of either the licensee's software program or encrypted electronic file 103 that is sent to the licensee's customers. Step 303 is the linking of customized ELR 106′ into licensee's software program to permit use of encrypted electronic file 104.

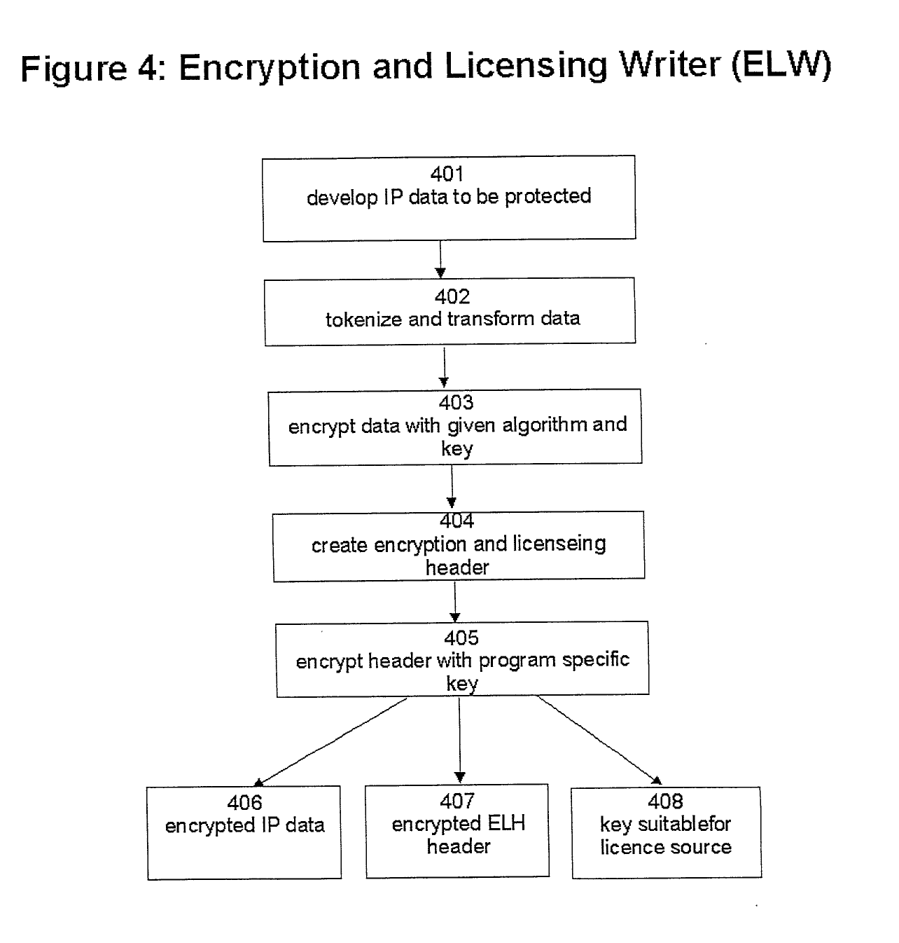

In the preferred embodiment, a licensor or distributor, for example, develops and encrypts electronic file 101 as shown in FIG. 4. At step 401, electronic file 101 is developed. At step 402, ELW 102 tokenizes and transforms electronic file 101 based on the types of tokenization algorithms that are available and what is appropriate for this particular type of data. For some electronic files 101 it is appropriate to compress the data in order to save space, but for other electronic files 101 compression is not used as it slows down the reading process. Depending upon the particular application, ELW 102 may use an alternate tokenization/transformation process.

ELW 102, at step 403, then encrypts tokenized/transformed electronic file 101 with an algorithm that has been configured for this instance of ELW 102. Encryption algorithms, while used in the preferred embodiment, are well known in the art and will not be further described herein. ELW 102 selects an appropriate one of an available encryption algorithm, which in the preferred embodiment includes a key, and uses it in the encryption of the tokenized/transformed electronic file 101 to produce encrypted electronic file 104.

ELW 102, at step 404, creates ELH 103 with the data needed for ELR 106 and, at step 405, encrypts ELH 103 using the configured key and algorithm that is shared with ELR 106. ELW 102 of the preferred embodiment then produces three outputs: encrypted electronic file 104 (step 406), an encrypted ELH (step 407), and the IP data key suitable for use in license source 108 (step 408).

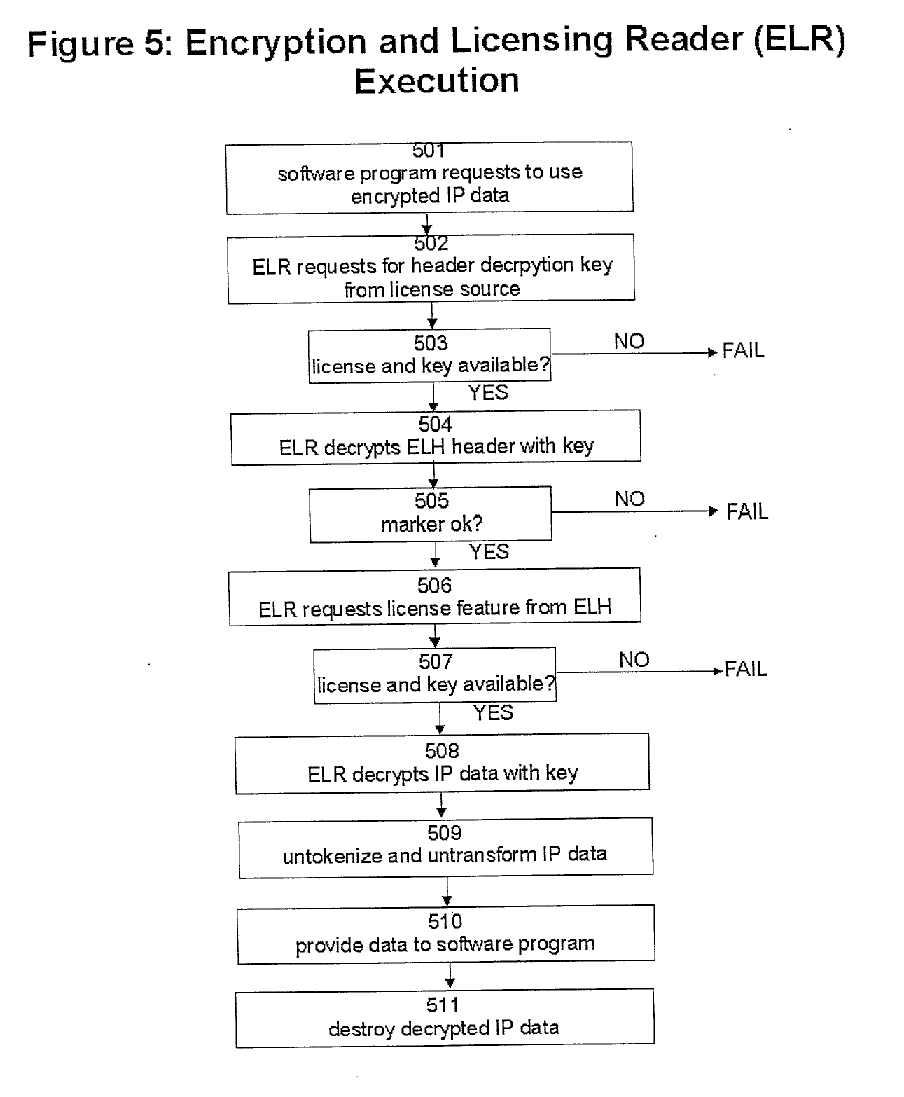

According to the preferred embodiment, when ELR 106 executes as part of the licensee's process (e.g. software program), the steps illustrated in FIG. 5 are implemented. Initially at step 501, a software program makes a request to use an encrypted electronic file 104. This may be by an explicit request to ELR 106 or by ELR 106 intercepting all or a specified subset of file open requests and checking whether they are encrypted by a recognized ELW. ELR 106 locates ELH 103 associated with encrypted electronic file 104. This ELH 103 may be part of encrypted electronic file 104 or be available elsewhere. ELR 106 requests, at step 502, ELH 103 decryption key from license source 108. In the preferred embodiment, this request uses either a fixed license feature name or generates a license feature name using the name of the electronic file in some way.

Step 503 tests whether the license and key are available. When the license is not available, a read failure is indicated to the software program. When the license is available, the process receives a key that is returned from license source 108 and ELR 106 advances to step 504 where encrypted ELH 103 is decrypted.

At step 505, ELR 106 tests the marker field from the decrypted ELH 103 to be certain ELH 103 has been decrypted properly. If the marker is not correct, a failure indication is returned to the software program. At step 506 (following a successful test of marker field at step 505), ELR 106 uses the license feature field of the decrypted ELH 103 to make a new request to license source 108 for a key to decrypt the encrypted electronic file 104. Step 507 has ELR 106 test whether the license and key are available. When the license is not available, a failure indication is returned to the software program.

A successful test at step 507 advances the process to step 508 where ELR 106 constructs the final decryption key by either using the key returned from the license server directly or by combining the key field of ELH 103 with the key from license source 108. In the preferred embodiment, at step 508 ELR 106 then begins to incrementally decrypt the IP data using the algorithm indicated in the algorithm identifier field of ELH. As each section of encrypted electronic file 104 is decrypted, ELR 106 (step 509) sends each decrypted section through the tokenization algorithms indicated by the tokenization field in ELH. After transformations, ELR 106 at step 510 sends each section of IP data into the software program's reader. Step 511 provides for ELR 106, as soon as the data has been consumed by the software program, to overwrite the decrypted data in the ELR's memory to prevent possible snooping. The preferred embodiment protects the decrypted electronic file in several ways: by decrypting only a portion of the file at one time, decrypting those portions into volatile memory (e.g., RAM), and limiting access to the volative RAM by applications other than the ELR. In the preferred embodiment, a double encryption/decryption system is used. In summary, the encrypted header is decrypted to unlock the decryption key that is used to decrypt the data.

It should be noted that the embodiments described here may be implemented in hardware, software, firmware or some combination thereof. While particular embodiments have been described, the scope of the invention is not to be limited to any particular embodiment. Rather, the scope of the invention is to be determined from the claims.

What is claimed is:

1. A method of accessing an electronic file, comprising:
querying a license server associated with an encrypted version of the electronic file in response to a read access request to the electronic file;
issuing a token from said license server according to an access policy when access to the electronic file is authorized; and
decrypting said encrypted version of said electronic file to a volatile memory using said token to produce the electronic file.

2. The accessing method of claim 1, further comprising:
limiting, after said decrypting step, access by all unauthorized processes to said volatile memory.

3. The accessing method of claim 1, further comprising:
inhibiting, after said decrypting step, transfer of the electronic file to a nonvolatile memory.

4. The accessing method of claim 1 wherein said querying step includes extracting a key from said encrypted version of the electronic file and using said key to access said license server.

5. The accessing method of claim 1 wherein said access policy limits a number of processes that concurrently access the electronic file in said volatile memory.

6. The accessing method of claim 1 wherein said access policy limits a number of operations on the electronic file in said volatile memory.

7. The accessing method of claim 1 wherein said access policy selectively enables decryption of a portion of the electronic file.

8. The accessing method of claim 1 wherein said decrypting step decrypts a portion of the file at any time and overwrites successive portions on top of previously decrypted portions.

9. The accessing method of claim 1 wherein decrypting step includes both a cryptological function and a tokenization and transformation function.

10. The accessing method of claim 1 wherein said read request is issued from an access program.

11. The accessing method of claim 10 wherein said access program is an interpreted program translator and the electronic file is source for said interpreted program translator.

12. The accessing method of claim 1 wherein said access policy provides for third party access control.

13. The accessing method of claim 1 wherein said license server is a local file.

14. The accessing method of claim 1 wherein said license server is a remote file not available on a computing system storing the encrypted electronic file.

15. The accessing method of claim 1 wherein said license server is coupled to the electronic file.

16. A method of producing an electronic file having embedded access control, comprising:
encrypting the electronic file with a first key to produce an encrypted electronic file; and
associating said encrypted electronic file with an access executable and a license server having an access policy for the electronic file, both operable on a computing system, said license server responsive to an access request from said access executable to issue a first token to said access executable according to said first key and said access policy, and said access executable responsive to said first token to decrypt said encrypted electronic file into a volatile memory protected by said access executable.

17. The producing method of claim 16 wherein encrypting step includes both a cryptological function and a tokenization and transformation function.

18. A method of providing access to a process executing on a computing system of an encrypted electronic file containing a plain electronic file, comprising:
issuing an access instruction from the process to access the plain electronic file;
querying a license server associated with the encrypted electronic file in response to said access instruction;
issuing a token from said license server according to an access policy when access to the plain electronic file is authorized, said token containing access authorization instructions;
decrypting so much of the encrypted electronic file to a volatile memory as authorized by said access authorization instructions to write all or a portion of the plain electronic file into said volatile memory; and
providing controlled access of said portion of the plain electronic file in said volatile memory to the process while inhibiting all other accesses to said volatile memory by other processes.

19. A system for accessing an electronic file, comprising:
means for querying a license server associated with an encrypted version of the electronic file in response to a read access request to the electronic file;
means, coupled to said querying means, for issuing a token from said license server according to an access policy when access to the electronic file is authorized; and
means, coupled to said issuing means, for decrypting said encrypted version of said electronic file to a volatile memory using said token to produce the electronic file.

20. A system for producing an electronic file having embedded access control, comprising:
means for encrypting the electronic file with a first key to produce an encrypted electronic file; and
means, coupled to said encrypting means, for associating said encrypted electronic file with an access executable and a license server having an access policy for the electronic file, both operable on a computing system, said license server responsive to an access request from said access executable to issue a first token to said access executable according to said first key and said access policy, and said access executable responsive to said first token to decrypt said encrypted electronic file into a volatile memory protected by said access executable.

21. A system for providing access to a process executing on a computing system of an encrypted electronic file containing a plain electronic file, comprising:
means for issuing an access instruction from the process to access the plain electronic file;
means, coupled to said access instruction issuing means, for querying a license server associated with the encrypted electronic file in response to said access instruction;
means, coupled to said querying means, for issuing a token from said license server according to an access policy when access to the plain electronic file is authorized, said token containing access authorization instructions;
means, coupled to said token issuing means, for decrypting so much of the encrypted electronic file to a volatile memory as authorized by said access authorization instructions to write all or a portion of the plain electronic file into said volatile memory; and
means, coupled to said decrypting means, for providing controlled access of said portion of the plain electronic file in said volatile memory to the process while inhibiting all other accesses to said volatile memory by other processes.
